(19) United States
(12) Patent Application Publication
(10) Pub. No.: US 2013/0148088 A1
(43) Pub. Date: Jun. 13, 2013

(54) APPARATUS CASING, PROJECTION SYSTEM AND ASSEMBLING METHOD OF APPARATUS CASING

(71) Applicants: Kuang-Yao Liu, Hsin-Chu (TW); I-Hsien Liu, Hsin-Chu (TW)

(72) Inventors: Kuang-Yao Liu, Hsin-Chu (TW); I-Hsien Liu, Hsin-Chu (TW)

(73) Assignee: CORETRONIC CORPORATION, Hsin-Chu (TW)

(21) Appl. No.: 13/556,205

(22) Filed: Jul. 24, 2012

(30) Foreign Application Priority Data
Dec. 8, 2011 (CN) 201110405764.5

(51) Int. Cl. G03B 21/20; B23P 17/04; F21V 15/01

(52) U.S. Cl. 353/119; 362/362; 29/464

(57) ABSTRACT

An apparatus casing including a first shell, a second shell covering the first shell, a sliding part, an elastic part and a position-limiting part is provided. The second shell has a slot. The slot includes two portions respectively having a first and a second width. The sliding part is slidably disposed in the first shell. The elastic part is compressed between the first shell and the sliding part. The position-limiting part is disposed at the sliding part. An end of the position-limiting part extends into the second shell through the slot. An external diameter of the end of the position-limiting part is greater than the first width but less than the second width. The sliding part withstands an elastic force generated by the elastic part to drive the end of the position-limiting part to move from a position of the first portion to a position of the second portion.

### CROSS-REFERENCE TO RELATED APPLICATION

This application claims the priority benefit of China application serial no. 201110405764.5, filed on Dec. 8, 2011. The entirety of the above-mentioned patent application is hereby incorporated by reference herein and made a part of this specification.

### BACKGROUND OF THE INVENTION

1. Field of the Invention

The invention generally relates to an apparatus casing, a projection system and an assembling method of the apparatus casing, and more particularly, to an apparatus casing for installing and fixing a laser light source, a projection system using the apparatus casing and an assembling and disassembling method of the apparatus casing.

2. Description of Related Art

The projector is a display device for producing a large size frame and works based on an imaging principle of converting an illumination light-beam produced by a light source module into an image light-beam through a light valve and then, projecting the image light-beam onto a screen or a wall to foam images through a projection lens. Along with the progress of the projection technology and the reducing of the production cost, the modern projector has been gradually expanded to home purpose from commercial purpose.

The projector could employ a light-emitting diode (LED) light source or a laser light source to provide the required projection light. In terms of the laser light source, the laser light source module of a projector available on the market could be easily detached by the user, which provides a loophole for a potential suspect to easily take away the laser light source for illegal purposes, and it may also injure the human body. Thus, if the laser light source is designed in this way which it could be smoothly detached only by a specific method, the above-mentioned risk of taking away the laser light source for other purpose could be avoided.

Taiwan Patent No. 390205 disclosed a positioning-sleeve structure of a connection-rod, where the sleeve structure could be in a movable state or a fixed state through an elastic deformation of an interlinking spring. US Patent Application No. 20070033975 disclosed a lock device, where a plurality of driver-pins and springs connected to the driver-pins are respectively disposed in a plurality of round holes. When a plurality of key-pins are respectively inserted into the round holes and respectively push the driver-pins to the specific positions, a key could drive a plug to turn so as to unlock the lock device.

### SUMMARY OF THE INVENTION

Accordingly, the invention is directed to an apparatus casing able to avoid being easily disassembled.

The invention is also directed to a projection system including an apparatus casing for fixing a laser light source able to avoid easily disassembling the apparatus casing.

The invention is further directed to an assembling method of apparatus casing able to avoid easily disassembling an apparatus casing assembled by using the said method.

Other objectives and advantages of the invention should be further indicated by the disclosures of the invention, and omitted herein for simplicity.

To achieve one of, a part of or all of the above-mentioned objectives, or to achieve other objectives, an embodiment of the invention provides an apparatus casing, which includes a first shell, a second shell, a first sliding part, a first elastic part and a first position-limiting part. The second shell covers the first shell and has a first slot, in which a first portion of the first slot has a first width and a second portion of the first slot has a second width. The first sliding part is slidably disposed in the first shell. The first elastic part is disposed in the first shell for being compressed between the first shell and the first sliding part. The first position-limiting part is disposed at the first sliding part, in which an end of the first position-limiting part relatively extends into the second shell through the first slot, an external diameter of the end of the first position-limiting part is greater than the first width, but less than the second width, and the first sliding part withstands elastic force of the first elastic part to drive the end of the first position-limiting part to move from a position corresponding to the first portion of the first slot to a position corresponding to the second portion of the first slot.

According to the above-mentioned apparatus casing, the first shell herein has a cavity, the second shell has an open-hole, a laser light source is disposed in the cavity, and the second shell limits the laser light source in the cavity and partially exposes the laser light source out of the second shell through the open-hole.

According to the above-mentioned apparatus casing, a side of the first shell herein has an opening for exposing the first sliding part.

According to the above-mentioned apparatus casing, the first shell herein has a first groove, the first groove is aligned to the first slot of the second shell and the first position-limiting part is capable of partially protruding out of the first shell through the first groove, in which the first position-limiting part and one end of the first groove form a structural interference to restrict a moving range of the first sliding part relatively to the first shell.

According to the above-mentioned apparatus casing, the second shell herein further has a second slot, a third portion of the second slot has a third width, and a fourth portion of the second slot has a fourth width.

The above-mentioned apparatus casing further includes: a second sliding part slidably disposed in the first shell; a second elastic part disposed in the first shell for being compressed between the first shell and the second sliding part; and a second position-limiting part disposed at the second sliding part, in which an end of the second position-limiting part relatively extends into the second shell through the second slot, an external diameter of the end of the second position-limiting part is greater than the third width of the second slot, but less than the fourth width, and the second sliding part withstands elastic force of the second elastic part so as to drive the end of the second position-limiting part to move from a position corresponding to the third portion of the second slot to a position corresponding to the fourth portion of the second slot. The first sliding part herein is capable of moving over a first distance to drive the end of the first position-limiting part to move from the position corresponding to the first portion of the first slot to the position corresponding to the second portion of the first slot, the second sliding part herein is capable of moving over a second distance to drive the end of the second position-limiting part to move from the position corresponding to the third portion of the second slot to the position corresponding to the fourth portion of the second slot, and the first distance is different from the second distance. A side of the first shell herein has two openings for respectively exposing the first sliding part and the second sliding part.

According to the above-mentioned apparatus casing, one of the first shell and the second shell has a plurality of positioning-holes and the other of the first shell and the second shell has a plurality of positioning-pillars, and when the second shell covers the first shell, the positioning-pillars are respectively inserted into the positioning-holes.

To achieve one of a part of or all of the above-mentioned objectives, or to achieve other objectives, an embodiment of the invention provides a projection system, which includes an apparatus casing, a laser light source, a light valve and a projection lens. The apparatus casing includes a first shell, a second shell, a first sliding part, a first elastic part and a first position-limiting part. The second shell covers the first shell and has a first slot, in which a first portion of the first slot has a first width and a second portion of the first slot has a second width. The first sliding part is slidably disposed in the first shell. The first elastic part is disposed in the first shell for being compressed between the first shell and the first sliding part. The first position-limiting part is disposed at the first sliding part, in which an end of the first position-limiting part relatively extends into the second shell through the first slot, an external diameter of the end of the first position-limiting part is greater than the first width of the first portion, but less than the second width of the second portion, and the first sliding part withstands elastic force of the first elastic part to drive the end of the first position-limiting part to move from a position corresponding to the first portion of the first slot to a position corresponding to the second portion of the first slot. The laser light source is position-limited between the first shell and the second shell for producing an illumination light-beam. The light valve is for converting the illumination light-beam into an image light-beam. The projection lens is for converting the image light-beam into a projection light-beam.

According to the above-mentioned projection system, the first shell herein has a cavity, the second shell has an open-hole, the laser light source is disposed in the cavity, the second shell limits the laser light source in the cavity and the laser light source is partially exposed out of the second shell through the open-hole. A side of the first shell has an opening for exposing the first sliding part. An object is disposed for pushing the first sliding part through the opening at the side of the first shell. The first shell has a first groove, the first groove is aligned to the first slot of the second shell and the first position-limiting part is capable of protruding out of the first shell through the first groove, in which the first position-limiting part and one end of the first groove form a structural interference to restrict a moving range of the sliding part relatively to the first shell.

According to the above-mentioned projection system, the second shell herein further has a second slot, a third portion of the second slot has a third width, and a fourth portion of the second slot has a fourth width.

According to the above-mentioned projection system, the apparatus casing herein further includes: a second sliding part slidably disposed in the first shell; a second elastic part disposed in the first shell for being compressed between the first shell and the second sliding part; and a second position-limiting part disposed at the second sliding part, in which an end of the second position-limiting part relatively extends into the second shell through the second slot, an external diameter of the end of the second position-limiting part is greater than the third width of the second slot, but less than the fourth width, and the second sliding part withstands elastic force of the second elastic part so as to drive the end of the second position-limiting part to move from a position corresponding to the third portion of the second slot to a position corresponding to the fourth portion of the second slot.

According to the above-mentioned projection system, the first sliding part herein is capable of moving over a first distance to drive the end of the first position-limiting part to move from the position corresponding to the first portion of the first slot to the position corresponding to the second portion of the first slot, the second sliding part is capable of moving over a second distance to drive the end of the second position-limiting part to move from the position corresponding to the third portion of the second slot to the position corresponding to the fourth portion of the second slot, and the first distance is different from the second distance. A side of the first shell has two openings for respectively exposing the first sliding part and the second sliding part.

According to the above-mentioned projection system, one of the first shell and the second shell has a plurality of positioning-holes and the other of the first shell and the second shell has a plurality of positioning-pillars, and when the second shell covers the first shell, the positioning-pillars are respectively inserted into the positioning-holes.

To achieve one of, a part of or all of the above-mentioned objectives, or to achieve other objectives, an embodiment of the invention provides an assembling method of apparatus casing, which includes: providing a first shell, a first sliding part, a first elastic part and a first position-limiting part, in which the first sliding part is slidably disposed in the first shell, the first elastic part is for being compressed between the first shell and the first sliding part, and the first position-limiting part is disposed at the first sliding part; providing a second shell, in which the second shell has a first slot, a first portion of the first slot has a first width, a second portion of the first slot has a second width, and an external diameter of an end of the first position-limiting part is greater than the first width of the first portion, but less than the second width of the second portion; aligning the second shell to the first shell, and applying force to the first sliding part for withstanding elastic force of the first elastic part to drive the end of the first position-limiting part to move from a position corresponding to the first portion of the first slot to a position corresponding to the second portion of the first slot; when the end of the first position-limiting part is aligned to the second portion, making the second shell cover the first shell and relatively placing the end of the first position-limiting part in the second shell through the first slot; and after relatively placing the end of the first position-limiting part in the second shell, stopping applying force to the first sliding part to resume the position of the first sliding part through the elastic force of the first elastic part, so as to drive the end of the first position-limiting part to move from the position corresponding to the second portion to the position corresponding to the first portion, such that the end of the first position-limiting part is limited and locked in the second shell.

Based on the above-mentioned embodiment of the invention, the end of the first position-limiting part relatively extends into the second shell through the first slot of the second shell and the external diameter of the end of the second position-limiting part is greater than the third width of the second slot, but less than the fourth width. Thus, when the first elastic part pushes the first sliding part through the elastic force thereof so that the end of the first position-limiting part is aligned to the first portion of the first slot, the first portion with a smaller width could limit and lock the end of the first position-limiting part in the second shell to prevent the first shell and the second shell from separation. At the time, the user must withstand the elastic force of the first elastic part to push the first sliding part, which makes the first sliding part move over a predetermined distance so as to drive the end of the first position-limiting part to move to be aligned to the second portion of the first slot. Only in this way, the end of the first position-limiting part is able to relatively move out of the second shell through the second portion with a larger width, which could avoid the apparatus casing from easily being disassembled.

According to the above-mentioned assembling method of an apparatus casing, the first shell herein has a cavity, the second shell has an open-hole, and the method further includes: disposing a laser light source in the cavity before making the second shell cover the first shell; and as making the second shell cover the first shell, limiting the laser light source in the cavity through the second shell and partially exposing the laser light source out of the second shell through the open-hole.

According to the above-mentioned assembling method of apparatus casing, a side of the first shell herein has an opening for exposing the first sliding part, and the step of applying force to the first sliding part for withstanding elastic force of the first elastic part includes: providing an object; and using the object to push the first sliding part through the opening at the side of the first shell.

According to the above-mentioned assembling method of apparatus casing, the second shell herein further has a second slot, a third portion of the second slot has a third width, and a fourth portion of the second slot has a fourth width, and the method further includes: providing a second sliding part, a second elastic part and a second position-limiting part, in which the second sliding part is slidably disposed in the first shell, the second elastic part is disposed in the first shell for being compressed between the first shell and the second sliding part, and the second position-limiting part is disposed at the second sliding part, in which an external diameter of an end of the second position-limiting part is greater than the third width of the second slot, but less than the fourth width; during driving the end of the first position-limiting part to move to the position corresponding to the second portion of the first slot, applying force to the second sliding part for withstanding elastic force of the second elastic part so as to drive the end of the second position-limiting part to move from a position corresponding to the third portion of the second slot to a position corresponding to the fourth portion of the second slot; during relatively placing the end of the first position-limiting part in the second shell through the second portion of the first slot, relatively placing the end of the second position-limiting part in the second shell through the fourth portion of the second slot; and after relatively placing the end of the second position-limiting part in the second shell, stopping applying force to the second sliding part to resume the position of the second sliding part through the elastic force of the second elastic part, so as to drive the end of the second position-limiting part to move from the position corresponding to the fourth portion of the second slot to the position corresponding to the third portion of the second slot, such that the end of the second position-limiting part is limited and locked in the second shell.

According to the above-mentioned assembling method of the apparatus casing, the step of driving the end of the first position-limiting part to move to the position corresponding to the second portion and driving the end of the second position-limiting part to move to the position corresponding to the fourth portion includes: moving the first sliding part over a first distance to drive the end of the first position-limiting part to move to the position corresponding to the second portion, and moving the second sliding part over a second distance to drive the end of the second position-limiting part to move to the position corresponding to the fourth portion, in which the first distance is different from the second distance

According to the above-mentioned assembling method of apparatus casing, a side of the first shell has two openings for respectively exposing the first sliding part and the second sliding part, and the step of applying force to the first sliding part for withstanding elastic force of the first elastic part and applying force to the second sliding part for withstanding elastic force of the second elastic part includes: providing an object having two pillars with different lengths; and using the two pillars of the object to push the first sliding part and the second sliding part through the two openings at the side of the first shell so as to drive the first sliding part and the second sliding part respectively moving over the first distance and the second distance.

According to the above-mentioned projection system, one of the first shell and the second shell has a plurality of positioning-holes and the other of the first shell and the second shell has a plurality of positioning-pillars, and the step of making the second shell cover the first shell includes respectively inserting the positioning-pillars correspondingly into the positioning-holes.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a projection system according to an embodiment of the invention.

FIG. 2 is a three-dimensional diagram of the apparatus casing and the laser light source in FIG. 1.

FIG. 3 is an exploded diagram of the apparatus casing and the laser light source in FIG. 2.

FIG. 4 is a partial cross-sectional diagram of the apparatus casing and the laser light source in FIG. 2.

FIG. 5 is a bottom-view of the second shell of FIG. 2.

FIG. 6A is a partial cross-sectional diagram where the end of the position-limiting part of FIG. 4 is aligned to the first portion of the slot of FIG. 5.

FIG. 6B is a partial cross-sectional diagram where the end of the position-limiting part of FIG. 4 is aligned to the second portion of the slot of FIG. 5.

FIGS. 7A and 7B are schematic action diagrams of the apparatus casing of FIG. 4.

FIG. 8 is a three-dimensional diagram of the apparatus casing and the laser light source according to another embodiment of the invention.

FIG. 9 is an exploded diagram of the apparatus casing and the laser light source in FIG. 8.

FIG. 10 is a partial cross-sectional diagram of the apparatus casing and the laser light source in FIG. 8.

FIG. 11 is a bottom-view of the second shell of FIG. 8.

FIG. 12A is a partial cross-sectional diagram where the end of the position-limiting part of FIG. 10 is aligned to the first portion of the slot of FIG. 11.

FIG. 12B is a partial cross-sectional diagram where the end of the position-limiting part of FIG. 10 is aligned to the second portion of the slot of FIG. 11.

FIGS. 13A and 13B are schematic action diagrams of the apparatus casing of FIG. 10.

FIG. 14 is a flowchart of an assembling method of the apparatus casing in FIG. 2.

FIG. 15 is a flowchart of an assembling method of the apparatus casing in FIG. 8.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

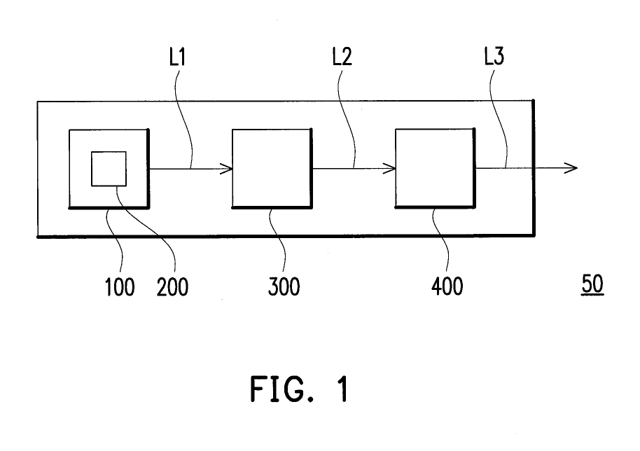

FIG. 1 is a schematic diagram of a projection system according to an embodiment of the invention. Referring to FIG. 1, a projection system 50 of the embodiment includes an apparatus casing 100, a laser light source 200, a light valve 300 and a projection lens 400. The laser light source 200 is disposed and position-limited in the apparatus casing 100 to produce an illumination light-beam L1. The light valve 300 is disposed on an transmission path of the illumination light-beam L1 for converting the illumination light-beam L1 into an image light-beam L2. The projection lens 400 is disposed on an transmission path of the image light-beam L2 for converting the image light-beam L2 into a projection light-beam L3.

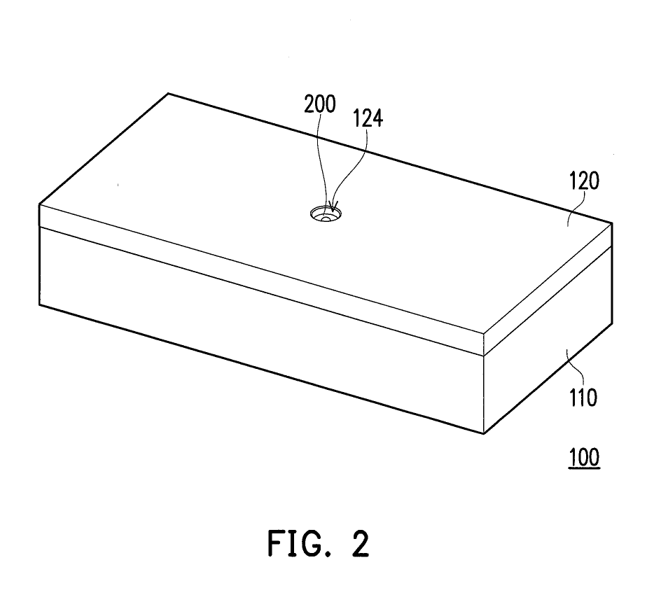

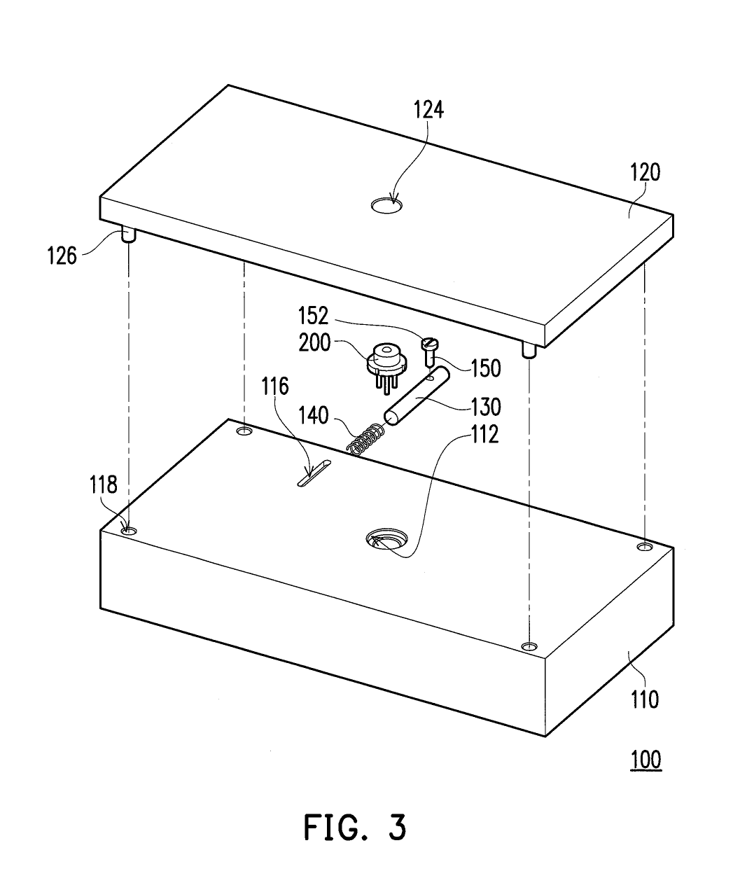

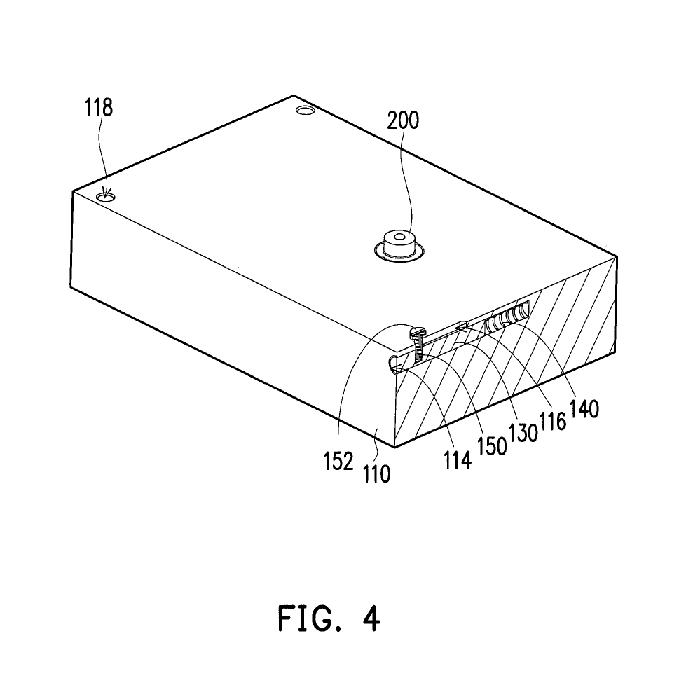

FIG. 2 is a three-dimensional diagram of the apparatus casing and the laser light source in FIG. 1, FIG. 3 is an exploded diagram of the apparatus casing and the laser light source in FIG. 2 and FIG. 4 is a partial cross-sectional diagram of the apparatus casing and the laser light source in FIG. 2. Referring to FIGS. 2-4, the apparatus casing 100 of the embodiment includes a first shell 110, a second shell 120, a sliding part 130, an elastic part 140 and a position-limiting part 150. The second shell 120 covers the first shell 110 and the laser light source 200 is fixed and position-limited between the first shell 110 and the second shell 120. The sliding part 130 is slidably disposed in the first shell 110. The elastic part 140 is disposed in the first shell 110 for being compressed between the first shell 110 and the sliding part 130. The position-limiting part 150 is disposed at the sliding part 130.

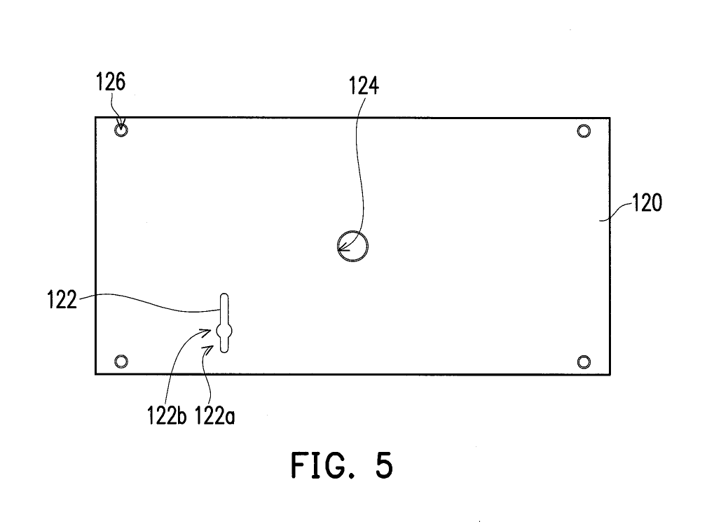

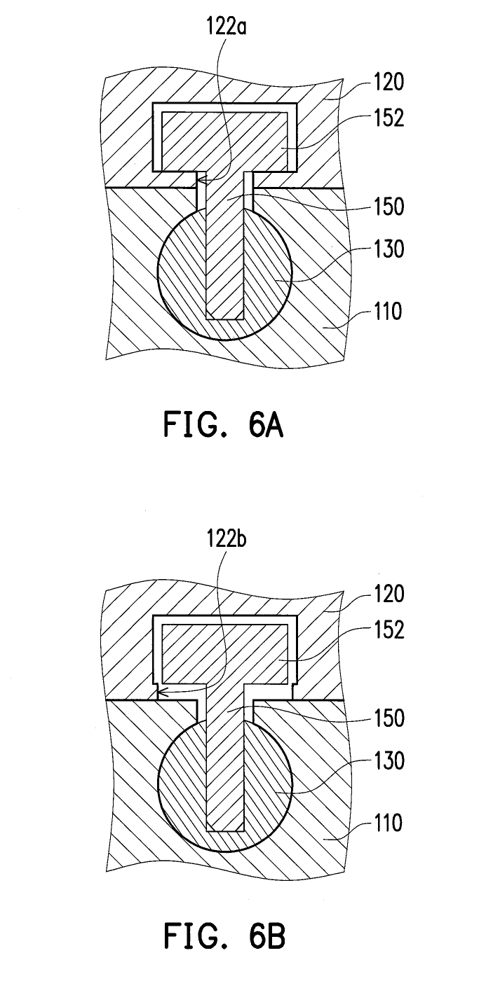

FIG. 5 is a bottom view of the second shell of FIG. 2, FIG. 6A is a partial cross-sectional diagram where an end of the position-limiting part of FIG. 4 is aligned to a first portion of a slot of FIG. 5 and FIG. 6B is a partial cross-sectional diagram where the end of the position-limiting part of FIG. 4 is aligned to a second portion of the slot of FIG. 5. Referring to FIGS. 5, 6A and 6B, the second shell 120 has a slot 122, and the slot 122 has a first portion 122a having a first width and a second portion 122b having a second width. The position-limiting part 150 has an end 152, in which an external diameter of the end 152 is greater than external diameters of the other portions of the position-limiting part 150 and the end 152 extends into the second shell 120 through the slot 122. The external diameter of the end 152 of the position-limiting part 150 is greater than the first width of the first portion 122a of the slot 122, but less than the second width of the second portion 122b of the slot 122 and the end 152 of the position-limiting part 150 relatively extends into the second shell 120 through the second portion 122b of the slot 122.

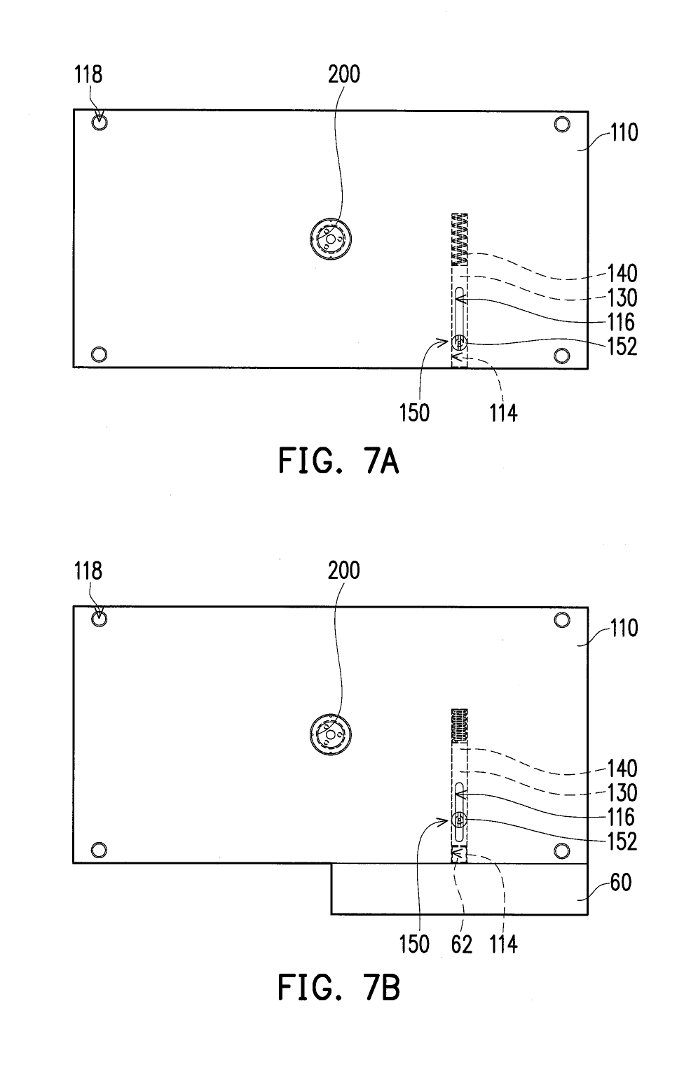

FIGS. 7A and 7B are schematic action diagrams of the apparatus casing of FIG. 4. When the sliding part 130 is pushed by an elastic force of the elastic part 140 and positioned at a position shown by FIG. 7A, the end 152 of the position-limiting part 150 would be aligned to the first portion 122a shown by FIGS. 5 and 6A. When the sliding part 130, through an external force, withstands the elastic force of the elastic part 140 to move from the position shown by FIG. 7A to a position shown by FIG. 7B, the sliding part 130 drives the end 152 of the position-limiting part 150 to move from a position corresponding to the first portion 122a shown by FIGS. 5 and 6A to a position corresponding to the second portion 122b shown by FIGS. 5 and 6B.

With the above-mentioned layout, when the elastic part 140, through the elastic force thereof, pushes the sliding part 130 to make the end 152 of the position-limiting part 150 aligned to the position corresponding to the first portion 122a of the slot 122, the first portion 122a with a smaller width could limit the end 152 of the position-limiting part 150 in the second shell 120 so as to prevent the first shell 110 and the second shell 120 from separation. At the time, the user must apply a force to withstand the elastic force of the elastic part 140 to push the sliding part 130, so that the sliding part 130 moves over a predetermined distance to drive the end 152 of the position-limiting part 150 to move to be aligned to the position corresponding to the second portion 122b of the slot 122. Only in this way, the end 152 of the position-limiting part 150 is allowed relatively moving out of the second shell 120 through the second portion 122b with a larger width, which avoids the apparatus casing 100 from being easily disassembled and prevents the laser light source 200 therein to be taken out for other purpose to injure human body.

The elastic part 140 of the embodiment is, for example, a compression spring, which the invention is not limited to. In other embodiments, the elastic part 140 could be other appropriate parts with elasticity. In addition, the position-limiting part 150 of the embodiment is, for example, a screw, and the end 152 is a screw head, which the invention is not limited to. In other embodiments, the position-limiting part 150 could be other appropriate parts.

Referring to FIGS. 2 and 3 again, the first shell 110 of the embodiment has a cavity 112 and the second shell 120 has an open-hole 124 corresponding to the cavity 112. The laser light source 200 is disposed in the cavity 112, the second shell 120 is aligned to and covers the first shell 110 and limits the laser light source 200 in the cavity 112, but the laser light source 200 could be partially exposed out of the apparatus casing 100 through the open-hole 124.

Referring to FIGS. 4, 7A and 7B, a side of the first shell 110 of the embodiment has an opening 114. The sliding part 130 slides in the first shell 110 relatively to the opening 114, while the opening 114 is capable of exposing the sliding part 130. For operation convenience, an object 60 with a pillar 62 is used to push the sliding part 130 to the position shown by FIG. 7B through the opening 114 at the side of the first shell 110. In addition the first shell 110 of the embodiment has a groove 116. The groove 116 is aligned to the slot 122 shown by FIG. 5, the position-limiting part 150 protrudes out of the first shell 110 through the groove 116, and the position-limiting part 150 and an end of the groove 116 form a structural interference to restrict a moving range of the sliding part 130 relatively to the first shell 110 to avoid the sliding part 130 from moving away from the first shell 110 through the opening 114 at the side of the first shell 110.

Referring to FIG. 3, the first shell 110 of the embodiment has a plurality of positioning-holes 118 and the second shell 120 has a plurality of positioning-pillars 126. When the second shell 120 covers the first shell 110, the positioning-pillars 126 are respectively inserted into the positioning-holes 118 to fix the second shell 120 at the first shell 110, in which each positioning-pillar 126 is corresponding to the slot 122 and disposed at the same side of the second shell 120, a distance between the second portion 122b of the slot 122 and the corresponding positioning-pillar 126 is substantially the same as the slidable predetermined distance of the sliding part 130, and the length of the pillar 62 of the object 60 is substantially the same as the predetermined distance as well. In other embodiments, the positioning-pillars 126 could be disposed at the first shell 110 and the positioning-holes 118 could be disposed at the second shell 120, which the invention is not limited to.

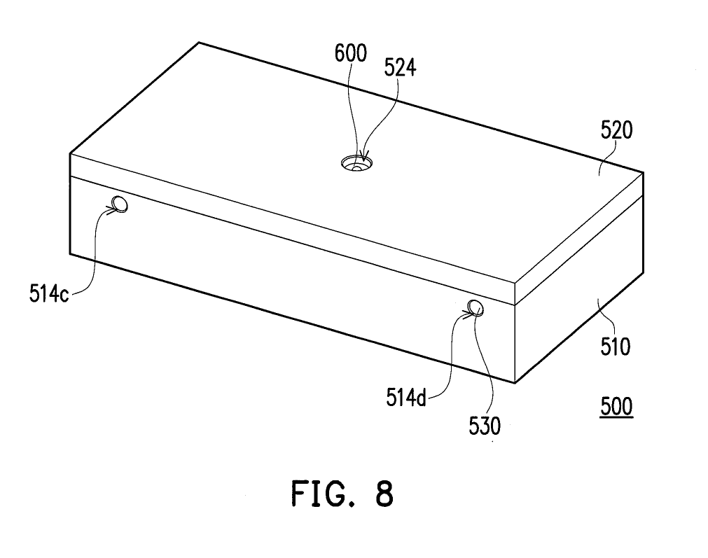

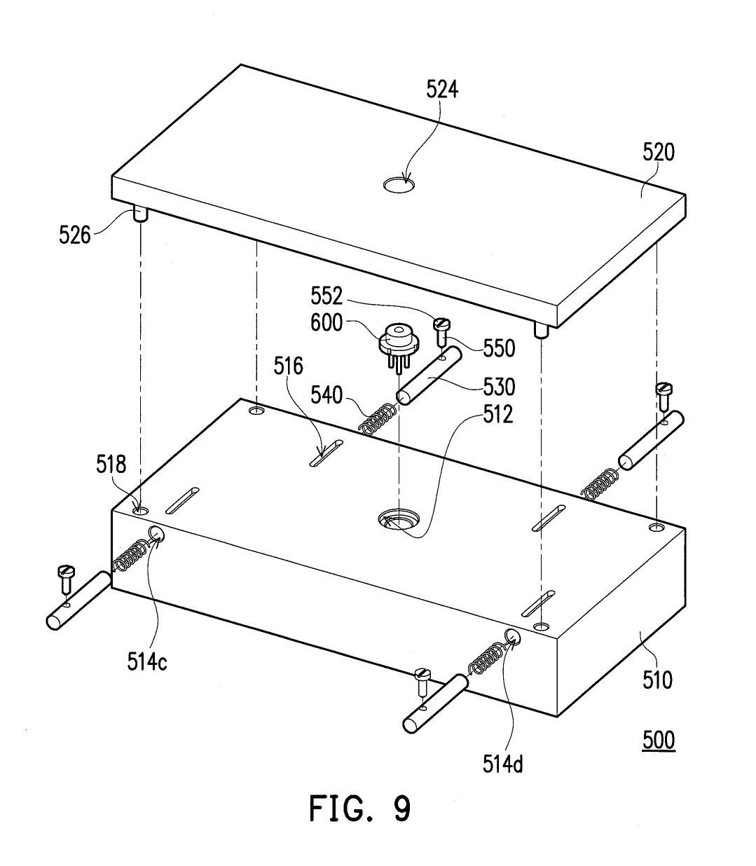

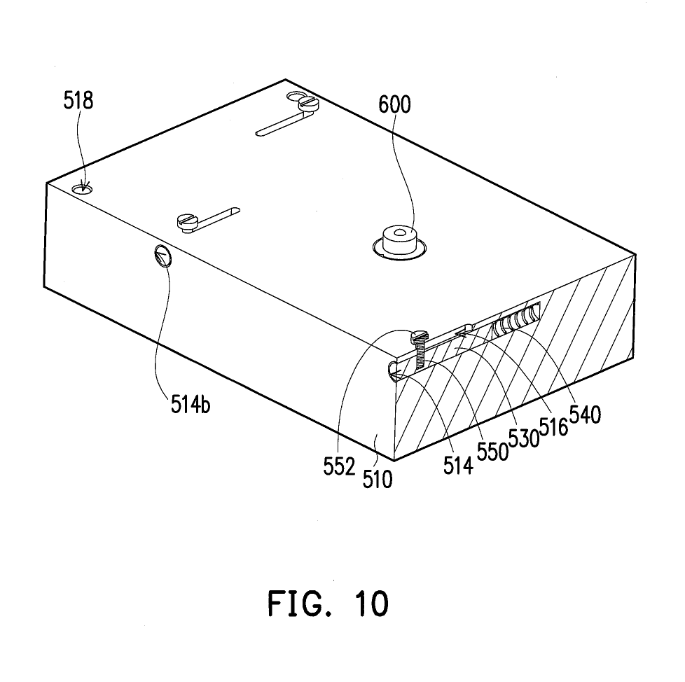

FIG. 8 is a three-dimensional diagram of the apparatus casing and the laser light source according to another embodiment of the invention, FIG. 9 is an exploded diagram of the apparatus casing and the laser light source in FIG. 8 and FIG. 10 is a partial cross-sectional diagram of the apparatus casing and the laser light source in FIG. 8. Referring to FIGS. 8-10, a apparatus casing 500 of the embodiment includes a first shell 510, a second shell 520, a plurality of sliding parts 530, a plurality of elastic parts 540 and a plurality of position-limiting parts 550. The second shell 520 covers the first shell 510 and the laser light source 600 is fixed and position-limited between the first shell 510 and the second shell 520. Each of the sliding parts 530 is slidably disposed in the first shell 510. Each of the elastic parts 540 is disposed in the first shell 510 for being compressed between the first shell 510 and the corresponding sliding part 530. Each of the position-limiting parts 550 is fixed at the corresponding sliding part 530. The first shell 510 has a plurality of positioning-holes 518 and the second shell 520 has a plurality of positioning-pillars 526 corresponding to the positioning-holes 518. When the second shell 520 correspondingly covers the first shell 510, the positioning-pillars 526 are respectively inserted into the positioning-holes 518 to position and fix the second shell 520 at the first shell 510. In other embodiments, the positioning-pillar 526 could be disposed at the first shell 510 and the positioning-hole 518 could be disposed at the second shell 520, which the invention is not limited to.

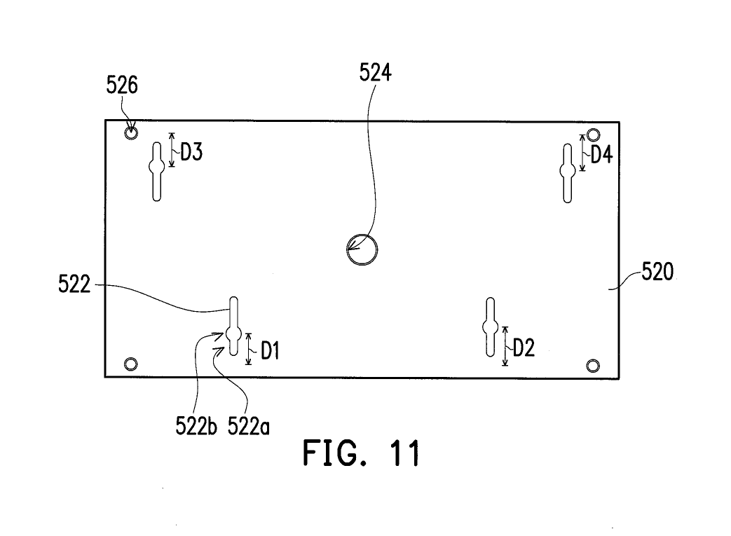

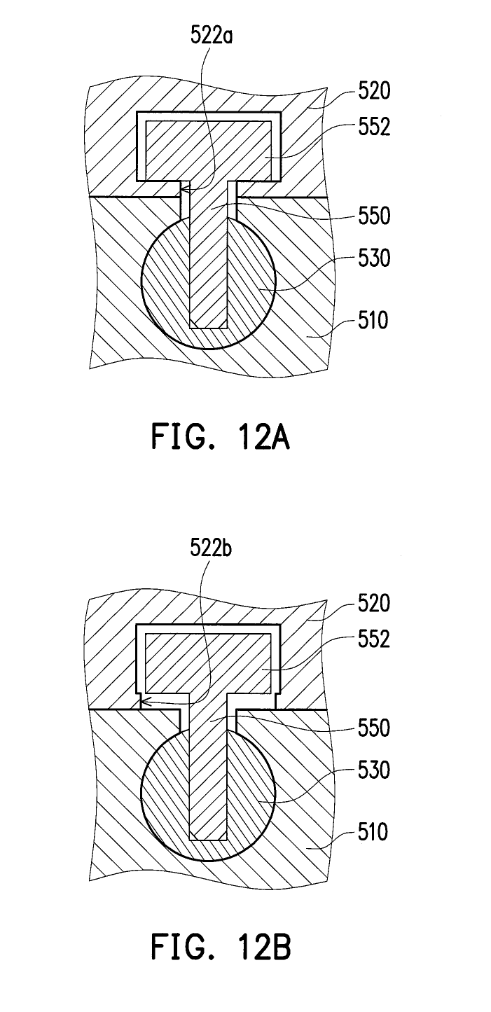

FIG. 11 is a bottom view of a second shell of FIG. 8, FIG. 12A is a partial cross-sectional diagram where an end of the position-limiting part of FIG. 10 is aligned to a first portion of a slot of FIG. 11 and FIG. 12B is a partial cross-sectional diagram where the end of the position-limiting part of FIG. 10 is aligned to a second portion of the slot of FIG. 11. Referring to FIGS. 11, 12A and 12B, the second shell 520 has a plurality of slots 522 and an end 552 of each of the position-limiting parts 550 relatively extends into the second shell 520 through the corresponding slot 522. Each of the slots 522 has a first portion 522a and a second portion 522b, in which an external diameter of the end 552 of each position-limiting part 550 is greater than an width of the first portion 522a of each slot 522, but less than an width of the second portion 522b of each slot 522.

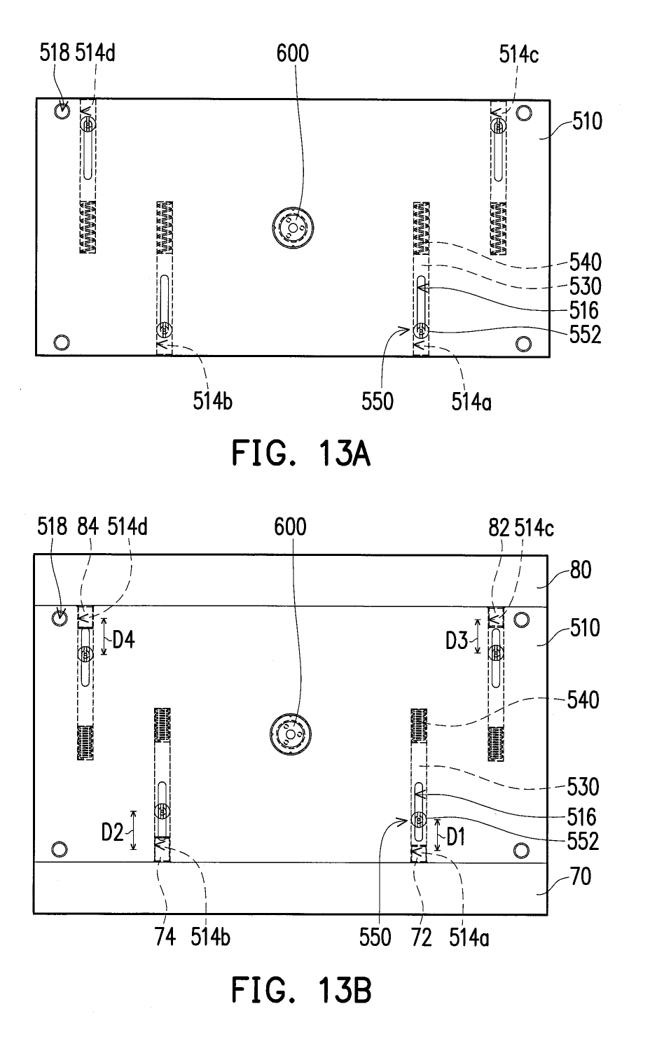

FIGS. 13A and 13B are schematic action diagrams of the apparatus casing of FIG. 10. When the sliding parts 530, respectively through the pushing of the elastic forces of the elastic parts 540, are positioned at the positions shown by FIG. 13A, the ends of the position-limiting parts 550 would be respectively aligned to the positions corresponding to the first portions 522a of the slots 522 shown by FIGS. 11 and 12A. When the sliding parts 530, through the external force, respectively withstand the elastic forces of the elastic parts 540 to move from the positions shown by FIG. 13A to the positions shown by FIG. 13B, the sliding parts 530 drive the ends 552 of the position-limiting parts 550 to move from the positions corresponding to the first portions 522a of the slots 522 shown by FIGS. 11 and 12A to the positions corresponding to the second portions 522b of the slots 522 shown by FIGS. 11 and 12B.

With the above-mentioned layout, when the elastic parts 540, through the elastic forces thereof, respectively push the sliding parts 530 to make the ends 552 of the position-limiting parts 550 respectively aligned to the positions corresponding to the first portions 522a of the slots 522, the first portions 522a with smaller widths of the slots 522 could limit the ends 552 of the corresponding position-limiting parts 550 in the second shell 520 so as to prevent the first shell 510 and the second shell 520 from separation. At the time, the user must apply a force to withstand the elastic forces of the elastic parts 540 to push the sliding parts 530, so that the sliding parts 530 moves over a predetermined distance to drive the ends 552 of the position-limiting parts 550 to move to be aligned to the positions corresponding to the second portions 522b of the slots 522. Only in this way, the end 552 of each the position-limiting part 550 is allowed relatively moving out of the second shell 520 through the second portion 522b with a larger width, which avoids the apparatus casing 500 from being easily disassembled and prevents the laser light source 600 therein to be taken out for other purpose to injure human body.

In the embodiment, the quantities of the slots 522, the sliding parts 530, the elastic parts 540 and the position-limiting parts 550 are four, which the invention is not limited to. In other embodiments, the quantities could be two, three, five or other appropriate numbers.

As shown in FIG. 11, four positioning-pillars 526 of the second shell 520 of the embodiment are respectively disposed at the outer sides of the four slots 522 to keep the same distances from the sides of the second shell 520. The distance between the second portion 522b of a slot 522 and the corresponding positioning-pillar 526 is D1, the distance between the second portion 522b of another slot 522 and the corresponding positioning-pillar 526 is D2, the distance between the second portion 522b of yet another slot 522 and the corresponding positioning-pillar 526 is D3 and the distance between the second portion 522b of yet another slot 522 and the corresponding positioning-pillar 526 is D4, in which the distances D1, D2, D3 and D4 are different from each other. Thus, the sliding parts 530 of FIG. 13A must respectively move over different distances to drive the ends 552 of the position-limiting parts 550 to move to the positions corresponding to the second portions 522b of the slots 522, which make the disassembling the apparatus casing 500 harder to avoid the apparatus casing 500 from being easily disassembled.

In more details, the user could use two objects 70 and 80 shown by FIG. 13B to push the sliding parts 530. The object 70 has two pillars 72 and 74 and the object 80 has two pillars 82 and 84, and the four pillars 72, 74, 82 and 84 respectively have a different length, in which the lengths of the pillars 72, 74, 82 and 84 are respectively and correspondingly in association with the above-mentioned distances D2, D1, D4 and D3. A side of the first shell 510 has two openings 514a and 514b, while there are other two openings 514c and 514d at an opposite side thereof. The openings 514a, 514b, 514c and 514d respectively expose the sliding parts 530. When the user, shown by FIG. 13B, makes the pillars 72 and 74 of the object 70 respectively inserted into the openings 514a and 514b at the side of the first shell 510 and makes the pillars 82 and 84 of the object 80 respectively inserted into the openings 514c and 514d at the other side of the first shell 510, the sliding parts 530 are pushed respectively by the pillars 72, 74, 82 and 84 respectively with different lengths, so that the ends 552 of the corresponding position-limiting parts 550 respectively moving over different distances to be aligned to the positions corresponding to the second portions 522b of the slots 522. In other words, the user must use an object 70 with two pillars 72 and 74 with different lengths and an object 80 with two pillars 82 and 84 with different specific lengths to smoothly disassemble or assemble the first shell 510 and the second shell 520 of the apparatus casing 500.

Each the elastic part 540 of the embodiment is, for example, a compression spring, which the invention is not limited to. In other embodiments, each the elastic part 540 could be other appropriate parts with elasticity. In addition, each the position-limiting part 550 of the embodiment is, for example, a screw, and the end 552 is a screw head, which the invention is not limited to. In other embodiments, the position-limiting part 550 could be other appropriate parts.

Referring to FIGS. 8 and 9 again, the first shell 510 of the embodiment has a cavity 512 and the second shell 520 has an open-hole 524. The laser light source 600 is disposed in the cavity 512, the second shell 520 limits the laser light source 600 in the cavity 512, but the laser light source 600 could be partially exposed out of the apparatus casing 500 through the open-hole 524.

Referring to FIGS. 10, 13A and 13B, the first shell 510 of the embodiment has a plurality of grooves 516, and the grooves 516 are respectively aligned to the slots 522 of the second shell 520 shown by FIG. 11. The ends 552 of the position-limiting parts 550, through the grooves 516, respectively protrude out of the first shell 510. Each of the position-limiting parts 550 and an end of the corresponding groove 516 form a structural interference to restrict the moving range of each the sliding part 530 relatively to the first shell 510 to avoid each of the sliding part 530 from moving away from the first shell 510 through the corresponding opening 514 at the side of the first shell 510.

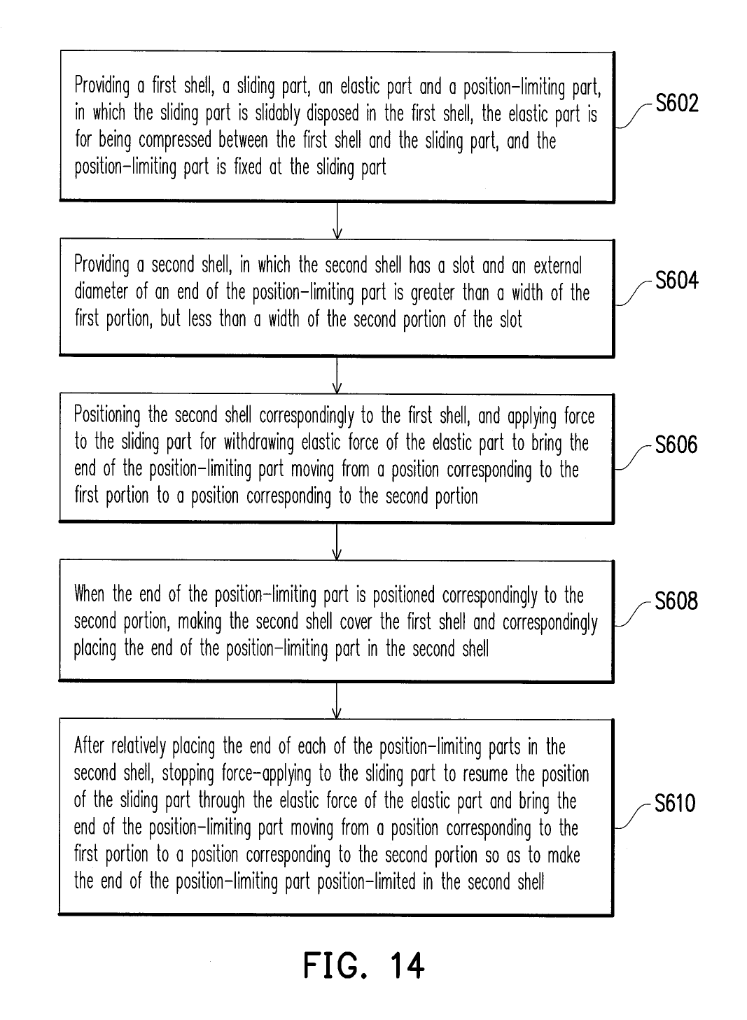

The flowchart of assembling the apparatus casing 100 is explained in following. FIG. 14 is a flowchart of an assembling method of the apparatus casing in FIG. 2. Referring to FIG. 14, first, a first shell 110, a sliding part 130, a elastic part 140 and a position-limiting part 150 are provided, in which the sliding part 130 is slidably disposed in the first shell 110, the elastic part 140 is compressed between the first shell 110 and the sliding part 130, and the position-limiting part 150 is fixed at the sliding part 130 (step S602). Next, a second shell 120 shown by FIG. 5 is provided, in which the second shell 120 has a slot 122, an external diameter of an end 152 of the position-limiting part 150 (shown by FIG. 4) is greater than a width of the first portion 122a of the slot 122, but less that a width of the second portion 122b of the slot 122 (step S604). The second shell 120 shown by FIG. 5 is aligned to the first shell 110 shown by FIG. 7A and the user applies a force to the sliding part 130 for withstanding the elastic force of the elastic part 140 so as to drive the end 152 of the position-limiting part 150 to move from the position corresponding to the first portion 122a shown by FIG. 7A to the position corresponding to the second portion 122b shown by FIG. 7B (step S606). When the end 152 of the position-limiting part 150 is aligned to the position corresponding to the second portion 122b of the slot 122, the second shell 120 covers the first shell 110, and the end 152 of the position-limiting part 150, shown by FIG. 6B, is relatively placed in the second shell 120 through the second portion 122b of the slot 122 (step S608). After the end 152 of the position-limiting part 150 is relatively placed in the second shell 120, the user stops applying the force to the sliding part 130, so that the sliding part 130 resumes the position through the elastic force of the elastic part 140, which drives the end 152 of the position-limiting part 150 to move from the position corresponding to the second portion 122b to the position corresponding to the first portion 122a, while the end 152 of the position-limiting part 150 is position-limited and locked in the second shell 120 shown by FIG. 6A (step S610) so as to finish the assembling job of the apparatus casing 100 shown by FIG. 2.

In more details, prior to covering the second shell 120 at the first shell 110, the laser light source 200 is placed in the cavity 112 of the first shell 110. When the second shell 120 covers the first shell 110 as described in step S608, the laser light source 200 is position-limited in the cavity 112 through the second shell 120, and the laser light source 200 is partially exposed out of the second shell 120 of the apparatus casing 100 through the open-hole 124.

In the above-mentioned step S606, the object 60 shown by FIG. 7B pushes the sliding part 130 through the opening 114 of the first shell 110 to apply a force to the sliding part 130 for withstand the elastic force of the elastic part 140. In addition, as described in step S608, when the second shell 120 covers the first shell 110, the positioning-pillars 126 of the second shell 120 are respectively inserted into the positioning-holes 118 of the first shell 110 to fix the second shell 120 at the first shell 110, the laser light source 200 could be thereby position-limited between the first shell 110 and the second shell 120.

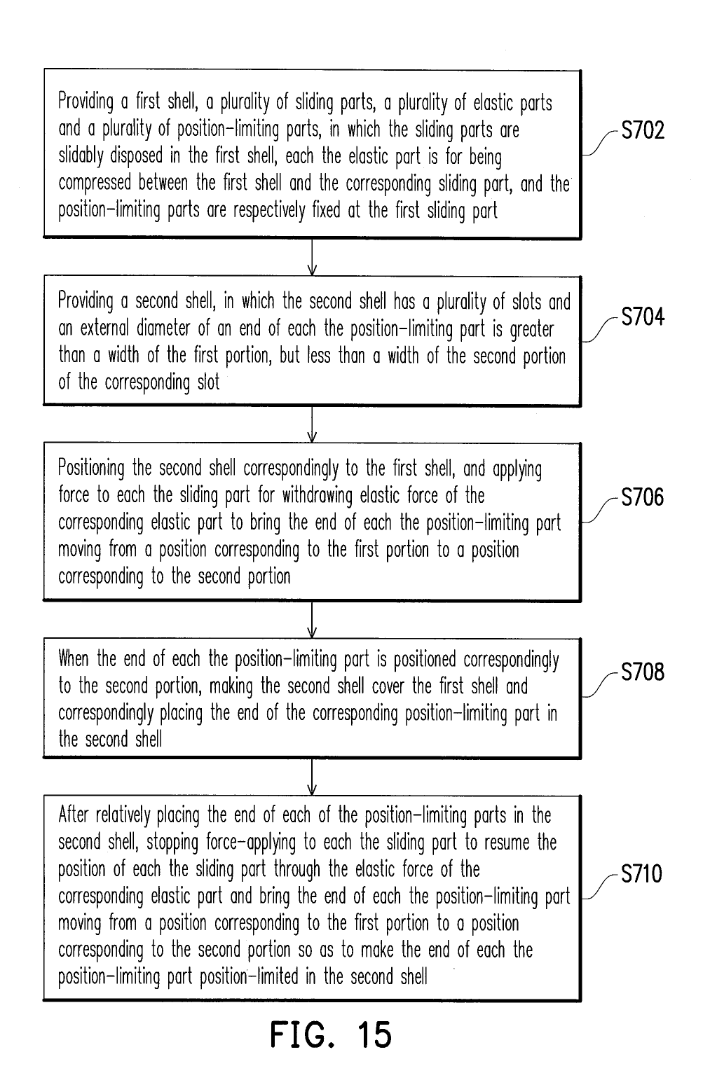

The flowchart of assembling the apparatus casing 500 shown by FIG. 8 is explained in following. FIG. 15 is a flowchart of an assembling method of the apparatus casing in FIG. 8. Referring to FIG. 15, first, a first shell 510, a plurality of sliding parts 530, a plurality of elastic parts 540 and a plurality of position-limiting parts 550 shown by FIG. 10 are provided, in which the sliding parts 530 are slidably disposed in the first shell 510, each of the elastic parts 540 is compressed between the first shell 510 and the corresponding sliding part 530, and the position-limiting parts 550 are respectively fixed at the sliding parts 530 (step S702). Next, the second shell 520 shown by FIG. 11 is provided, in which the second shell 520 has a plurality of slots 522, the external diameter of the end 552 of each position-limiting part 550 shown by FIG. 10 is greater than the width of the first portion 522a of the slot 522, but less than the width of the second portion 522b of the corresponding slot 522 (step S704). Then, the second shell 520 shown by FIG. 11 is aligned to the first shell 510 shown by FIG. 13A and a force is applied to each of the sliding parts 530 for withstanding the external force of the corresponding elastic part 540 so as to drive the end 552 of each of the position-limiting parts 550 to move from the positions corresponding to the first portions 522a shown by FIG. 123 to the positions corresponding to the second portions 522b shown by FIG. 13B (step S706). When the end 552 of each of the position-limiting parts 550 is aligned to the positions corresponding to the second portions 522b, the second shell 520 covers the first shell 510 and, as shown by FIG. 12B, the end 552 of each of the position-limiting parts 550 is relatively placed in the second shell 520 through the second portions 522b of the corresponding slot 522 (step S708). After the end 552 of each of the position-limiting parts 550 is relatively placed in the second shell 520, it stops applying the force to each of the sliding parts 530, so that each of the sliding parts 530 resumes position through the elastic force of the corresponding elastic part 540, which drives the ends 552 of the position-limiting parts 550 to move from the positions corresponding to the second portions 522b of the slots 522 to the positions corresponding to the first portions 522a, and at the time, as shown by FIG. 12A, the end 552 of each of the position-limiting parts 550 is position-limited and locked in the second shell 520 (step S710) to finish the assembling job of the apparatus casing 500 shown by FIG. 8.

In more details, before covering the second shell 520 at the first shell 510, the laser light source 600 is placed in the cavity 512 of the first shell 510. When the second shell 520 covers the first shell 510 as described in step S708, the laser light source 600 is position-limited in the cavity 512 through the second shell 520, and the laser light source 600 is partially exposed out of the second shell 520 through the open-hole 524.

In the above-mentioned step S706, as shown by FIG. 13B, two objects 70 and 80 are used to push the sliding parts 530 through four openings 514a, 514b, 514c and 514d of the first shell 510, which withstands the external forces of the elastic parts 540 applied to the sliding parts 530. In addition, when the second shell 520 covers the first shell 510 as described in step S708, the positioning-pillars 526 of the second shell 520 are respectively inserted into the positioning-holes 518 of the first shell 510 to fix the second shell 520 at the first shell 510.

In more details, in the above-mentioned step S706, when the user, as shown by FIG. 13B, makes the pillars 72 and 74 of the object 70 respectively inserted into the openings 514a and 514b of at the same side of the first shell 510 and makes the pillars 82 and 84 of the object 80 respectively inserted into the openings 514c and 514d of at the same side of the first shell 510, the sliding parts 530 are pushed respectively by the pillars 72, 74, 82 and 84 respectively with different lengths, so that the sliding parts 530 respectively move over different distances to be aligned to the positions corresponding to the second portions 522b of the slots 522.

In summary, in the above-mentioned embodiments of the invention, the end of the position-limiting part relatively extends into the second shell through the slot of the second shell and the external diameter of the end of the position-limiting part is greater than the width of the first portion of the slot, but less than the width of the second portion of the slot. Thus, when the elastic part pushes the sliding part through the elastic force thereof so that the end of the position-limiting part is aligned to the position corresponding to the first portion of the slot, the first portion with a smaller width could limit and lock the end of the position-limiting part in the second shell to prevent the first shell and the second shell from separation. At the time, the user must apply a force for withstand the elastic force of the elastic part to push the sliding part, which makes the sliding part move over a predetermined distance so as to drive the end of the position-limiting part to move to be aligned to the position corresponding to the second portion of the slot. Only in this way, the end of the position-limiting part is able to relatively move out of the second shell through the second portion with a larger width, which could avoid the apparatus casing from easily being disassembled and prevent the laser light source therein to be taken out for other purpose to injure human body. In the embodiments, the quantities of the slots, the sliding parts, the elastic parts and the position-limiting parts are four. In addition, the distance between the second portion of each slot and the corresponding positioning-pillar could be different from the distances between the second portions of other slots and the corresponding positioning-pillars to further make the disassembling job of the apparatus casing much harder to avoid the user from easily disassembling the apparatus casing.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An apparatus casing, comprising:
a first shell;
a second shell, covering the first shell and having a first slot, wherein a first portion of the first slot has a first width and a second portion of the first slot has a second width;
a first sliding part, slidably disposed in the first shell;
a first elastic part, disposed in the first shell for being compressed between the first shell and the first sliding part; and
a first position-limiting part, disposed at the first sliding part, wherein an end of the first position-limiting part relatively extends into the second shell through the first slot, an external diameter of the end of the first position-limiting part is greater than the first width of the first portion, but less than the second width of the second portion, and the first sliding part withstands elastic force of the first elastic part to drive the end of the first position-limiting part to move from a position corresponding to the first portion of the first slot to a position corresponding to the second portion of the first slot.

2. The apparatus casing as claimed in claim 1, wherein the first shell has a cavity, the second shell has an open-hole, a laser light source is capable of disposing in the cavity of the first shell, and is limited in the cavity by the second shell, and the laser light source is partially exposed out of the second shell through the open-hole.

3. The apparatus casing as claimed in claim 1, wherein a side of the first shell has an opening for exposing the first sliding part.

4. The apparatus casing as claimed in claim 1, wherein the first shell has a first groove, the first groove is aligned to the first slot of the second shell and the first position-limiting part is capable of partially protruding out of the first shell through the first groove.

5. The apparatus casing as claimed in claim 4, wherein the first position-limiting part and one end of the first groove form a structural interference to restrict a moving range of the first sliding part relatively to the first shell.

6. The apparatus casing as claimed in claim 1, wherein the second shell further has a second slot, a third portion of the second slot has a third width, and a fourth portion of the second slot has a fourth width.

7. The apparatus casing as claimed in claim 6, further comprising:
a second sliding part, slidably disposed in the first shell;
a second elastic part, disposed in the first shell for being compressed between the first shell and the second sliding part; and
a second position-limiting part, disposed at the second sliding part, wherein an end of the second position-limiting part relatively extends into the second shell through the second slot, an external diameter of the end of the second position-limiting part is greater than the third width of the second slot, but less than the fourth width, and the second sliding part withstands elastic force of the second elastic part so as to drive the end of the second position-limiting part to move from a position corresponding to the third portion of the second slot to a position corresponding to the fourth portion of the second slot.

8. The apparatus casing as claimed in claim 7, wherein the first sliding part is capable of moving over a first distance to drive the end of the first position-limiting part to move from the position corresponding to the first portion of the first slot to the position corresponding to the second portion of the first slot, the second sliding part is capable of moving over a second distance to drive the end of the second position-limiting part to move from the position corresponding to the third portion of the second slot to the position corresponding to the fourth portion of the second slot, and the first distance is different from the second distance.

9. The apparatus casing as claimed in claim 7, wherein a side of the first shell has two openings for respectively exposing the first sliding part and the second sliding part.

10. The apparatus casing as claimed in claim 1, wherein one of the first shell and the second shell has a plurality of positioning-holes and the other of the first shell and the second shell has a plurality of positioning-pillars, and when the second shell covers the first shell, the positioning-pillars are respectively inserted into the positioning-holes.

11. A projection system, comprising:
an apparatus casing, comprising:
a first shell;
a second shell, covering the first shell and having a first slot, wherein a first portion of the first slot has a first width and a second portion of the first slot has a second width;
a first sliding part, slidably disposed in the first shell;
a first elastic part, disposed in the first shell for being compressed between the first shell and the first sliding part; and
a first position-limiting part, disposed at the first sliding part, wherein an end of the first position-limiting part relatively extends into the second shell through the first slot, an external diameter of the end of the first position-limiting part is greater than the first width of the first portion, but less than the second width of the second portion, and the first sliding part withstands elastic force of the first elastic part to move and drive the end of the first position-limiting part to move from a position corresponding to the first portion of the first slot to a position corresponding to the second portion of the first slot; and
a laser light source, limited between the first shell and the second shell for producing an illumination light-beam;
a light valve, for converting the illumination light-beam into an image light-beam, wherein the light valve is disposed on a transmission path of the illumination light-beam from the laser light source; and
a projection lens, for converting the image light-beam into a projection light-beam, wherein the projection lens is disposed on a transmission path of the image light-beam transmitted from the light valve.

12. The projection system as claimed in claim 11, wherein the first shell has a cavity, the second shell has an open-hole, the laser light source is capable of disposing in the cavity, and is limited in the cavity by the second shell, and the laser light source is partially exposed out of the second shell through the open-hole.

13. The projection system as claimed in claim 11, wherein a side of the first shell has an opening for exposing the first sliding part.

14. The projection system as claimed in claim 11, wherein the first shell has a first groove, the first groove is aligned to the first slot of the second shell and the first position-limiting part is capable of partially protruding out of the first shell through the first groove.

15. The projection system as claimed in claim 14, wherein the first position-limiting part and one end of the first groove form a structural interference to restrict a moving range of the first sliding part relatively to the first shell.

16. The projection system as claimed in claim 11, wherein the second shell further has a second slot, a third portion of the second slot has a third width, and a fourth portion of the second slot has a fourth width.

17. The projection system as claimed in claim 16, wherein the apparatus casing further comprises:
a second sliding part, slidably disposed in the first shell;
a second elastic part, disposed in the first shell for being compressed between the first shell and the second sliding part; and
a second position-limiting part, disposed at the second sliding part, wherein an end of the second position-limiting part relatively extends into the second shell through the second slot, an external diameter of the end of the second position-limiting part is greater than the third width of the second slot, but less than the fourth width, and the second sliding part withstands elastic force of the second elastic part so as to drive the end of the second position-limiting part to move from a position corresponding to the third portion of the second slot to a position corresponding to the fourth portion of the second slot.

18. The projection system as claimed in claim 17, wherein the first sliding part is capable of moving over a first distance to drive the end of the first position-limiting part to move from the position corresponding to the first portion of the first slot to the position corresponding to the second portion of the first slot, the second sliding part is capable of moving over a second distance to drive the end of the second position-limiting part to move from the position corresponding to the third portion of the second slot to the position corresponding to the fourth portion of the second slot, and the first distance is different from the second distance.

19. The projection system as claimed in claim 17, wherein a side of the first shell has two openings for respectively exposing the first sliding part and the second sliding part.

20. The projection system as claimed in claim 11, wherein one of the first shell and the second shell has a plurality of positioning-holes and the other of the first shell and the second shell has a plurality of positioning-pillars, and when the second shell covers the first shell, the positioning-pillars are respectively inserted into the positioning-holes.

21. An assembling method of an apparatus casing, comprising:
providing a first shell, a first sliding part, a first elastic part and a first position-limiting part, wherein the first sliding part is slidably disposed in the first shell, the first elastic part is for being compressed between the first shell and the first sliding part, and the first position-limiting part is disposed at the first sliding part;
providing a second shell, wherein the second shell has a first slot, a first portion of the first slot has a first width, a second portion of the first slot has a second width, and an external diameter of an end of the first position-limiting part is greater than the first width of the first portion, but less than the second width of the second portion;
aligning the second shell to the first shell, and applying force to the first sliding part for withstanding elastic force of the first elastic part to drive the end of the first position-limiting part to move from a position corresponding to the first portion of the first slot to a position corresponding to the second portion of the first slot;
when the end of the first position-limiting part is aligned to the second portion, making the second shell cover the first shell and relatively placing the end of the first position-limiting part in the second shell through the first slot; and
after relatively placing the end of the first position-limiting part in the second shell, stopping applying force to the first sliding part to resume the position of the first sliding part through the elastic force of the first elastic part, so as to drive the end of the first position-limiting part to move from the position corresponding to the second portion to the position corresponding to the first portion, such that the end of the first position-limiting part is limited in the second shell.

22. The assembling method of apparatus casing as claimed in claim 21, wherein the first shell has a cavity, the second shell has an open-hole, and the method further comprises:
disposing a laser light source in the cavity before making the second shell cover the first shell; and
as making the second shell cover the first shell, limiting the laser light source in the cavity through the second shell and partially exposing the laser light source out of the second shell through the open-hole.

23. The assembling method of apparatus casing as claimed in claim 21, wherein a side of the first shell has an opening for exposing the first sliding part, and the step of applying force to the first sliding part for withstanding elastic force of the first elastic part comprises:
providing an object; and
using the object to push the first sliding part through the opening at the side of the first shell.

24. The assembling method of apparatus casing as claimed in claim 21, wherein the second shell further has a second slot, a third portion of the second slot has a third width, and a fourth portion of the second slot has a fourth width, and the method further comprises:
providing a second sliding part, a second elastic part and a second position-limiting part, wherein the second sliding part is slidably disposed in the first shell, the second elastic part is disposed in the first shell for being compressed between the first shell and the second sliding part, and the second position-limiting part is disposed at the second sliding part, wherein an external diameter of an end of the second position-limiting part is greater than the third width of the second slot, but less than the fourth width;
during driving the end of the first position-limiting part to move to the position corresponding to the second portion of the first slot, applying force to the second sliding part for withstanding elastic force of the second elastic part to so as to drive the end of the second position-limiting part to move from a position corresponding to the third portion of the second slot to a position corresponding to the fourth portion of the second slot;
during relatively placing the end of the first position-limiting part in the second shell through the second portion of the first slot, relatively placing the end of the second position-limiting part in the second shell through the fourth portion of the second slot; and
after relatively placing the end of the second position-limiting part in the second shell, stopping applying force to the second sliding part to resume the position of the second sliding part through the elastic force of the second elastic part, so as to drive the end of the second position-limiting part to move from the position corresponding to the fourth portion of the second slot to the position corresponding to the third portion of the second slot, such that the end of the second position-limiting part is limited and locked in the second shell.

25. The assembling method of apparatus casing as claimed in claim 24, wherein the step of driving the end of the first position-limiting part to move to the position corresponding to the second portion and driving the end of the second position-limiting part to move to the position corresponding to the fourth portion comprises:
moving the first sliding part over a first distance to drive the end of the first position-limiting part to move to the position corresponding to the second portion, and
moving the second sliding part over a second distance to drive the end of the second position-limiting part to move to the position corresponding to the fourth portion, wherein the first distance is different from the second distance

26. The assembling method of apparatus casing as claimed in claim 23, wherein a side of the first shell has two openings for respectively exposing the first sliding part and the second sliding part, and the step of applying force to the first sliding part for withstanding elastic force of the first elastic part and applying force to the second sliding part for withstanding elastic force of the second elastic part comprises:
providing an object having two pillars with different lengths; and
using the two pillars of the object to push the first sliding part and the second sliding part through the two openings at the side of the first shell so as to drive the first sliding part and the second sliding part respectively moving over the first distance and the second distance.

27. The projection system as claimed in claim 11, wherein one of the first shell and the second shell has a plurality of positioning-holes and the other of the first shell and the second shell has a plurality of positioning-pillars, and the step of making the second shell cover the first shell comprises:
respectively inserting the positioning-pillars correspondingly into the positioning-holes.
